(19) United States
(12) Patent Application Publication
(10) Pub. No.: US 2015/0061635 A1
(43) Pub. Date: Mar. 5, 2015

(54) VOLTAGE CONVERTING INTEGRATED CIRCUIT

(71) Applicant: Novatek Microelectronics Corp., Hsinchu (TW)

(72) Inventors: Zhen-Guo Ding, Tainan City (TW); Chun-Yu Hsieh, Taichung City (TW)

(73) Assignee: Novatek Microelectronics Corp., Hsinchu (TW)

(21) Appl. No.: 14/074,680

(22) Filed: Nov. 7, 2013

(30) Foreign Application Priority Data
Sep. 5, 2013 (TW) 102132014

(51) Int. Cl. H02M 3/04

(52) U.S. Cl. CPC H02M 3/04
USPC 323/304

(57) ABSTRACT

A voltage converting integrated circuit includes a first switch, a second switch, a third switch, a fourth switch, and a control circuit. The first switch is coupled between a first voltage pin and a first switch pin. The second switch is coupled between a second voltage pin and a second switch pin. The third switch is coupled between the first switch pin and a third voltage pin. The fourth switch is coupled between the second switch pin and a reference ground. The first to the fourth switches are controlled by a control signal to be turned on or off. The control circuit is coupled to the first to the fourth switches for receiving a mode setting signal and the control circuit generates a control signal according to the mode setting signal.

### CROSS-REFERENCE TO RELATED APPLICATION

This application claims the priority benefit of Taiwan application serial no. 102132014, filed on Sep. 5, 2013. The entirety of the above-mentioned patent application is hereby incorporated by reference herein and made a part of this specification.

### BACKGROUND OF THE INVENTION

1. Field of the Invention

The invention relates to a voltage converting integrated circuit and particularly relates to a mode-variable voltage converting integrated circuit.

2. Description of Related Art

In the technical field of the conventional boost voltage converting circuits, common boost voltage converting circuits include inductive and capacitive voltage converting circuits.

The capacitive voltage converting circuit has a capacitor and a plurality of switches. The capacitive voltage converting circuit changes voltage levels received at two ends of the capacitor by repeatedly switching the switches, and through charging/discharging of the capacitor, the voltage converting circuit can be enhanced such that the voltage level of the generated boost output voltage is several times greater than the voltage level of the input voltage, thereby completing the boost operation.

The inductive voltage converting circuit has an inductor and multiple switches. Through periodical switching of the switches, the inductor can repeatedly perform charging/discharging according to the input voltage, thereby generating the boost output voltage that is several times greater than the input voltage.

The applications of the capacitive voltage converting circuit and the inductive voltage converting circuit require different circuit elements. To provide two options, i.e. capacitive voltage converting circuit and inductive voltage converting circuit, in an integrated voltage converting circuit for the user's choice, many pins will be required. As a result, the layout area of the integrated circuit will be increased and result in higher production costs.

### SUMMARY OF THE INVENTION

The invention provides a voltage converting integrated circuit having a variable operation mode.

A voltage converting integrated circuit of the invention includes a first switch, a second switch, a third switch, a fourth switch, and a control circuit. The first switch is coupled between a first voltage pin and a first switch pin and is controlled by a control signal to be turned on or off. The second switch is coupled between a second switch pin and a second voltage pin and is controlled by the control signal to be turned on or off. The third switch is coupled between the first switch pin and a third voltage pin and is controlled by the control signal to be turned on or off. The fourth switch is coupled between the second switch pin and a reference ground and is controlled by the control signal to be turned on or off. The control signal is coupled to the first, second, third, and fourth switches and receives a mode setting signal to generate the control signal.

In an embodiment of the invention, the mode setting signal sets the voltage converting integrated circuit to an inductive boost circuit or a capacitive boost circuit.

In an embodiment of the invention, the first voltage pin is used to receive an input voltage; the second and third voltage pins generate a boost output voltage; the first and second switch pins are coupled to a first terminal of an inductor; a second terminal of the inductor receives the input voltage; and the mode setting signal sets the voltage converting integrated circuit to the inductive boost circuit.

In an embodiment of the invention, the first and second voltage pins are used to receive an input voltage; the third voltage pin generates a boost output voltage; the first and second switch pins are coupled to a first terminal of an inductor; a second terminal of the inductor receives the input voltage; and the mode setting signal sets the voltage converting integrated circuit to the inductive boost circuit.

In an embodiment of the invention, the second voltage pin generates a boost output voltage; the second switch pin is coupled to a first terminal of an inductor; a second terminal of the inductor receives an input voltage; the first and third voltage pins and the first switch pin are floating-connected; and the mode setting signal sets the voltage converting integrated circuit to the inductive boost circuit.

In an embodiment of the invention, the first and second voltage pins are used to receive an input voltage; the third voltage pin generates a boost output voltage; the first switch pin is coupled to a first terminal of a capacitor; the second switch pin is coupled to a second terminal of the capacitor; and the mode setting signal sets the voltage converting integrated circuit to the capacitive boost circuit.

In an embodiment of the invention, the voltage converting integrated circuit further includes a mode setting pin coupled to the control circuit to receive the mode setting signal.

In an embodiment of the invention, the voltage converting integrated circuit further includes a mode setting signal generator coupled to the control circuit to generate the mode setting signal.

Based on the above, the voltage converting integrated circuit of the invention has switches disposed in the fixed pins. Through different connection relationships between the voltage pins and switch pins and the capacitor or inductor, and with use of the mode setting signal to generate the control signal to control the switches, one single voltage converting integrated circuit can serve as the capacitive or inductive boost circuit without increasing the number of the pins, which improves the efficiency of use of the voltage converting integrated circuit.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a diagram illustrating a voltage converting integrated circuit 100 according to an embodiment of the invention.

FIG. 2A is a diagram illustrating a voltage converting integrated circuit 200 according to another embodiment of the invention.

FIG. 2B is a diagram illustrating an alteration of the voltage converting integrated circuit 200 according to another embodiment of the invention.

FIG. 3A to FIG. 3D are diagrams illustrating voltage converting integrated circuits according to different embodiments.

### DESCRIPTION OF THE EMBODIMENTS

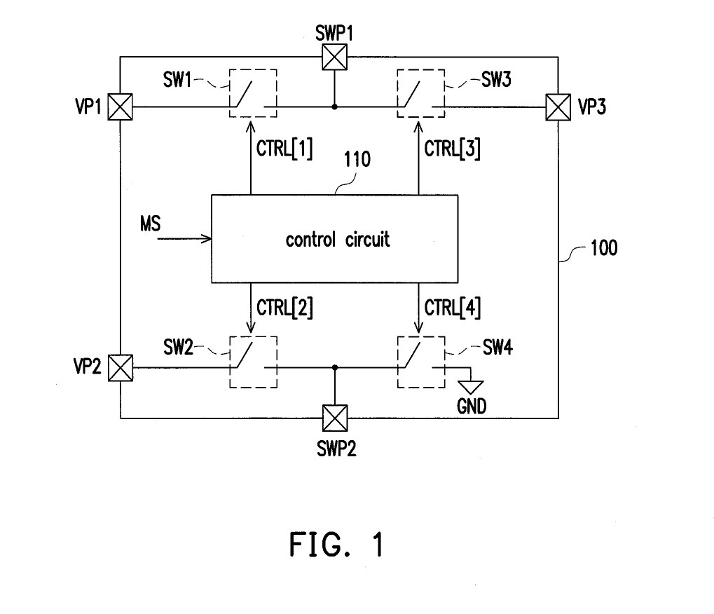

Hereinafter, please refer to FIG. 1. FIG. 1 is a diagram illustrating a voltage converting integrated circuit 100 according to an embodiment of the invention. The voltage converting integrated circuit 100 includes switches SW1-SW4, a control circuit 110, voltage pins VP1-VP3, and switch pins SWP1 and SWP2. The switch SW1 is coupled between the voltage pin VP1 and the switch pin SWP1. The switch SW2 is coupled between the voltage pin VP2 and the switch pin SWP2. The switch SW3 is coupled between the voltage pin VP3 and the switch pin SWP1. The switch SW4 is coupled between a reference ground GND and the switch pin SWP2. In addition, the switches SW1-SW4 are all coupled to the control circuit 110, and the control circuit 110 generates a control signal CTRL, wherein the control signal CTRL includes control signals CTRL[1]-CTRL[4].

The switches SW1-SW4 are respectively controlled by the control signals CTRL[1]-CTRL[4] to be turned on or off, wherein the switches SW1-SW4 can be repeatedly turned on or off according to the control signals CTRL[1]-CTRL[4] respectively, and the switches SW2 and SW4 are not turned on at the same time.

In addition, the control circuit 110 further receives a mode setting signal MS and generates the control signals CTRL[1]-CTRL[4] according to the mode setting signal MS, wherein the mode setting signal MS is used for setting the voltage converting integrated circuit 100 to a capacitive boost circuit or an inductive boost circuit. When the mode setting signal MS sets the voltage converting integrated circuit 100 to the capacitive boost circuit, the control signals CTRL[1]-CTRL[4] generated by the control circuit 110 control the switches SW1-SW4 to perform a switching operation corresponding to the capacitive boost circuit. On the other hand, when the mode setting signal MS sets the voltage converting integrated circuit 100 to the inductive boost circuit, the control signals CTRL[1]-CTRL[4] generated by the control circuit 110 control the switches SW1-SW4 to perform a switching operation corresponding to the inductive boost circuit.

The switch switching operations of the capacitive boost circuit and the inductive boost circuit are commonly known to persons ordinarily skilled in the art and thus will not be repeated hereinafter.

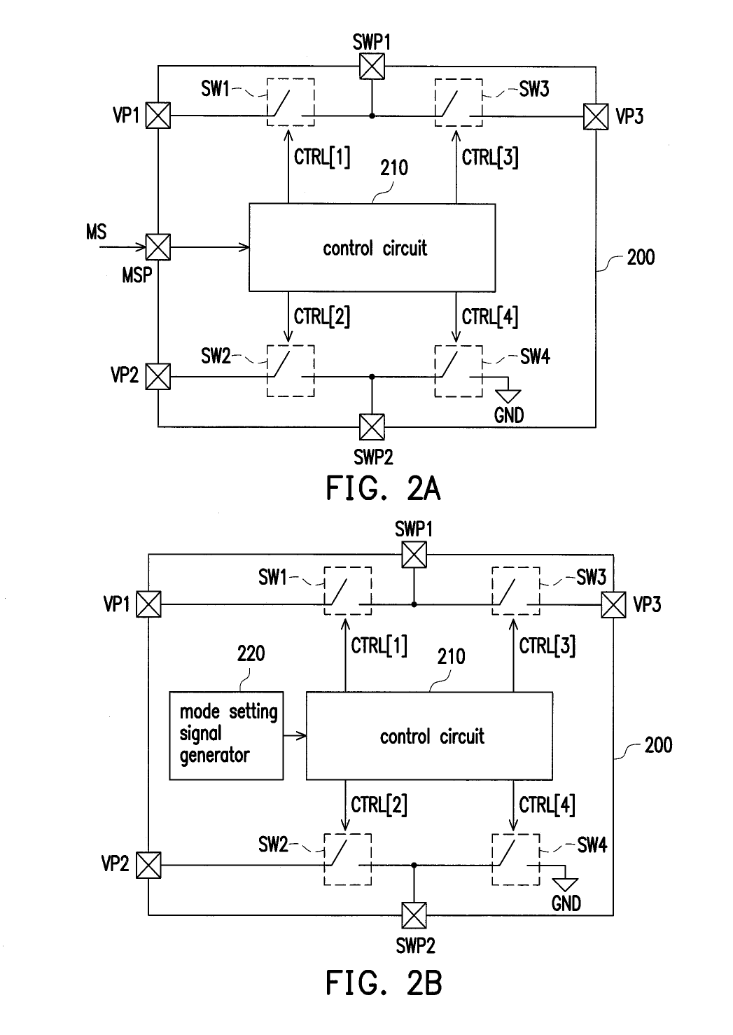

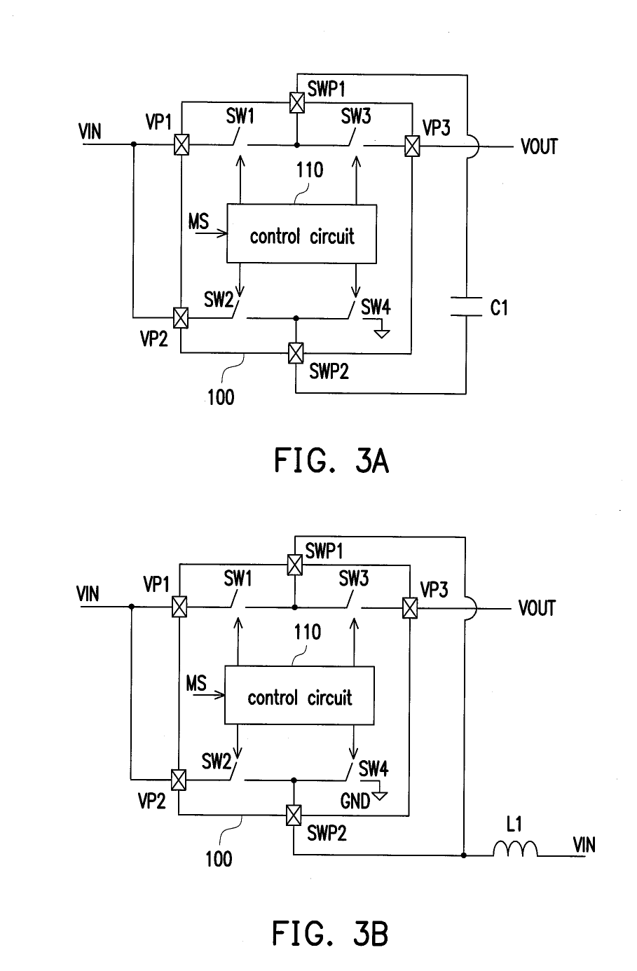

Please refer to FIG. 2A. FIG. 2A is a diagram illustrating a voltage converting integrated circuit 200 according to another embodiment of the invention. The voltage converting integrated circuit 200 includes the switches SW1-SW4, a control circuit 210, the voltage pins VP1-VP3, and the switch pins SWP1 and SWP2. Moreover, the voltage converting integrated circuit 200 further includes a mode setting pin MSP. The mode setting pin MSP is coupled to the control circuit 210. The control circuit 210 can receive the mode setting signal MS from outside the voltage converting integrated circuit 200 via the mode setting pin MSP. That is, the voltage converting integrated circuit 200 can perform a setting operation of the mode setting signal MS through a pin option, or can transmit the mode setting signal MS via another integrated circuit outside the voltage converting integrated circuit 200 to set an operation mode of the voltage converting integrated circuit 200.

Please refer to FIG. 2B. FIG. 2B illustrates an alteration of the voltage converting integrated circuit 200 according to another embodiment of the invention. In FIG. 2B, the voltage converting integrated circuit 200 is not provided with the mode setting pin MSP but further includes a mode setting signal generator 220. The mode setting signal generator 220 is coupled to the control circuit 210 to generate the mode setting signal MS and transmit the mode setting signal MS to the control circuit 210, wherein the mode setting signal generator 220 may be a read-only memory and generate the mode setting signal MS according to data stored therein. A user can burn and write in data to the mode setting signal generator 220, so as to set the mode setting signal MS. Otherwise, the mode setting signal generator 220 may be a command decoder, and the user can transmit command data to the mode setting signal generator 220 to enable the mode setting signal generator 220 to decode the command data transmitted by the user, so as to generate the mode setting signal MS.

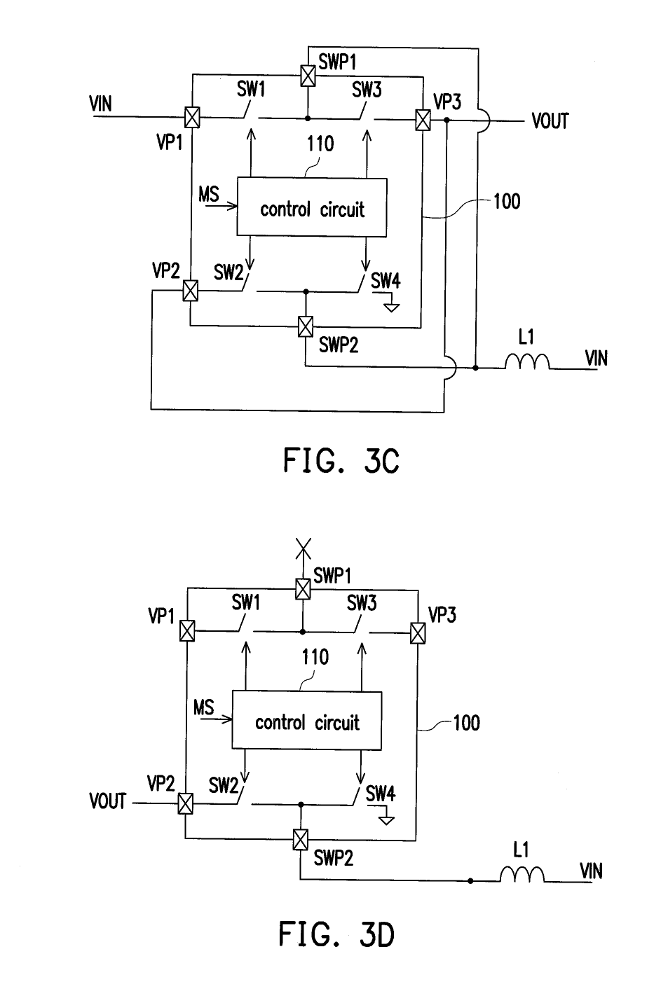

In terms of application circuit, the voltage converting integrated circuit may connect different passive elements via the voltage pins and the switch pins according to different operation modes that are to be performed. Below please refer to FIG. 3A to FIG. 3D. FIG. 3A to FIG. 3D are diagrams illustrating voltage converting integrated circuits according to different embodiments.

In FIG. 3A, the voltage converting integrated circuit 100 is used to connect a capacitor C1 and an input voltage VIN, so as to set the voltage converting integrated circuit 100 to the capacitive boost circuit. The voltage pins VP1 and the VP2 together receive the input voltage VIN. The switch pin SWP1 is coupled to a first terminal of the capacitor C1 while the switch pin SWP2 is coupled to a second terminal of the capacitor C1. Accordingly, the control circuit 110 is set by the mode setting signal MS for the switches SW1-SW4 to perform the switching operation of the capacitive boost circuit, and a boost output voltage VOUT can be generated on the voltage pin VP3 of the voltage converting integrated circuit 100.

In FIG. 3B, the voltage pins VP1 and VP2 together receive the input voltage VIN. The switch pins SWP1 and SWP2 are both coupled to a first terminal of an inductor L1, and a second terminal of the inductor L1 is coupled to the input voltage VIN. In addition, the control circuit 110 is set by the mode setting signal MS for the switches SW1-SW4 to perform the switching operation of the inductive boost circuit, and the boost output voltage VOUT can be generated on the voltage pin VP3 of the voltage converting integrated circuit 100.

In FIG. 3C, the voltage pin VP1 receives the input voltage VIN. The switch pins SWP1 and SWP2 are both coupled to the first terminal of the inductor L1, and the second terminal of the inductor L1 is coupled to the input voltage VIN. In addition, the voltage pin VP2 is coupled to the voltage pin VP3. The control circuit 110 is set by the mode setting signal MS for the switches SW1-SW4 to perform the switching operation of the inductive boost circuit, and the boost output voltage VOUT can be generated on the voltage pin VP3 of the voltage converting integrated circuit 100.

In FIG. 3D, the switch pin SWP2 is coupled to the first terminal of the inductor L1, and the second terminal of the inductor L1 is coupled to the input voltage VIN. In addition, the voltage pins VP1 and VP3 and the switch pin SWP1 are all floating-connected. The control circuit 110 is set by the mode setting signal MS for the switches SW2 and SW4 to perform the switching operation of the inductive boost circuit, and the boost output voltage VOUT can be generated on the voltage pin VP2 of the voltage converting integrated circuit 100. It is worth mentioning that, in this embodiment, the switches SW1 and SW3 can be constantly maintained in an off state.

In conclusion of the above, the voltage converting integrated circuit of the invention is capable of connecting different passive elements through fixed pins and chooses to perform the capacitive or inductive boost operation in accordance with the setting of the mode setting signal MS, thereby generating the boost output voltage. Accordingly, the choosing operation of the boost mode does not require many pins, and the costs of the circuit can be saved effectively.

It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. A voltage converting integrated circuit, comprising:
a first switch coupled between a first voltage pin and a first switch pin and controlled by a control signal to be turned on or off;
a second switch coupled between a second switch pin and a second voltage pin and controlled by the control signal to be turned on or off;
a third switch coupled between the first switch pin and a third voltage pin and controlled by the control signal to be turned on or off;
a fourth switch coupled between the second switch pin and a reference ground and controlled by the control signal to be turned on or off; and
a control circuit coupled to the first, second, third, and fourth switches and receiving a mode setting signal to generate the control signal.

2. The voltage converting integrated circuit according to claim 1, wherein the mode setting signal sets the voltage converting integrated circuit to an inductive boost circuit or a capacitive boost circuit.

3. The voltage converting integrated circuit according to claim 2, wherein the first voltage pin receives an input voltage; the second and third voltage pins generate a boost output voltage; the first and second switch pins are coupled to a first terminal of an inductor; a second terminal of the inductor receives the input voltage; and the mode setting signal sets the voltage converting integrated circuit to the inductive boost circuit.

4. The voltage converting integrated circuit according to claim 2, wherein the first and second voltage pins receive an input voltage; the third voltage pin generates a boost output voltage; the first and second switch pins are coupled to a first terminal of an inductor; a second terminal of the inductor receives the input voltage; and the mode setting signal sets the voltage converting integrated circuit to the inductive boost circuit.

5. The voltage converting integrated circuit according to claim 2, wherein the second voltage pin generates a boost output voltage; the second switch pin is coupled to a first terminal of an inductor; a second terminal of the inductor receives the input voltage; the first and third voltage pins and the first switch pin are floating-connected; and the mode setting signal sets the voltage converting integrated circuit to the inductive boost circuit.

6. The voltage converting integrated circuit according to claim 2, wherein the first and second voltage pins receive an input voltage; the third voltage pin generates a boost output voltage; the first switch pin is coupled to a first terminal of a capacitor; the second switch pin is coupled to a second terminal of the capacitor; and the mode setting signal sets the voltage converting integrated circuit to the capacitive boost circuit.

7. The voltage converting integrated circuit according to claim 1, further comprising a mode setting pin coupled to the control circuit to receive the mode setting signal.

8. The voltage converting integrated circuit according to claim 1, further comprising a mode setting signal generator coupled to the control circuit to generate the mode setting signal.
